(19) United States
(12) Patent Application Publication
(10) Pub. No.: US 2007/0056399 A1
(43) Pub. Date: Mar. 15, 2007

(54) Transmission actuator and control method therefore

(76) Inventors: Robert John Barnes, Staffordshire (GB); Richard Gareth Griffith, Gwynedd (GB)

Correspondence Address: PRICE HENEVELD COOPER DEWITT & LITTON, LLP, 695 KENMOOR, S.E., P O BOX 2567, GRAND RAPIDS, MI, 49501, US

(21) Appl. No.: 10/550,650

(22) PCT Filed: Mar. 24, 2004
(86) PCT No.: PCT/GB04/01240

§ 371 Date: Jul. 17, 2006

(30) Foreign Application Priority Data
Mar. 27, 2003 (GB) 0307118.0

(51) Int. Cl. F16H 61/30

(52) U.S. Cl. 74/335

(57) ABSTRACT

An actuator for actuating a gear shift mechanism in a vehicular transmission system, the actuator comprising: an actuator body (40) having an opening (43) for the transport of fluid into and out of the actuator body; an actuating member (42) within the actuator body, moveable by the fluid; and a control device (410, 416) operable to control independently the pressure of the fluid and the flow of the fluid.

### FIELD OF THE INVENTION

The invention relates to a drive transmission, in particular, a drive transmission comprising shift rails which are hydraulically actuated.

### BACKGROUND OF THE INVENTION

One known form of drive transmission is a dual clutch transmission, such as the DSG transmission used in the Audi TT. A typical dual clutch transmission is shown schematically in FIG. 1. In a vehicle system, drive from an engine 12 is coupled to the wheels (not shown) via a dual clutch transmission designated generally 14. The transmission 14 includes first and second clutches 18 and 20 and respective first and second input shafts 22 and 24. The input shafts 22 and 24 carry respective first and second gear sets 26 and 28. In the embodiment shown, the first gear set 26 carries gears 1,3, 5 and 7 (designated schematically) and the second gear set 28 carries gears reverse, 2,4 and 6 (designated schematically). A gear of either or both gear sets 26,28 is selectively engagable with a corresponding gear of an output gear set 30 on an output shaft 32 which is coupled to the vehicle wheels by an appropriate intermediate linkage. It will be appreciated that the arrangement shown is simplified and in practice the arrangements may be more complex although operating on the same principal. For example, the clutches 18,20 can be mounted co-axially.

In operation, when the vehicle is, for example, in fifth gear, the first clutch 18 is fully engaged with the engine 12, with the relevant gear of gear set 26 engaging the relevant gear of gear set 30 on the output shaft 32. The second clutch 20 is fully disengaged from the engine 12 but can be engaged with the output shaft 32 by means of a gear in the gear set 28 and the second input shaft 24. If a gear shift is required (for example to fourth gear) and the required gear on the second input shaft 24 is not already engaged with the output shaft 32, then, with the second clutch 20 remaining disengaged from the engine, the appropriate gear of the second gear set 28 is synchronized with the relevant gear of the output gear set 30 and then engaged such that clutch 20 spins freely and not in synchronization with the engine speed. In the downshift from fifth to fourth gear, the second clutch 20 will typically be rotating faster than the engine speed and so, to synchronize the engine speed with the speed of the second clutch 20, the first clutch 18 is disengaged until slipping starts, at which point the engine speed rises. As the engine speed approaches the second clutch speed, the second clutch 20 is engaged and the first clutch 18 disengaged.

As explained with reference to FIG. 1, an input shaft 22,24 is provided for each gear set 26,28. A shift rail 34 is provided to shift a selector fork 36 between a neutral position and an engaged position in which a synchronizer clutch 38 is moved into engagement with a gear on an input shaft, which is itself already in engagement with a gear of the output gear set 30. To move a selector fork 36, hydraulic fluid is passed through conduits to actuate an associated actuator 40 connected to the shift rail 34 and hence cause the associated selector fork 36 to move as required and the associated synchronizer clutch 38 to move into engagement with a gear on an input shaft.

Another known type of transmission is an automated manual transmission (AMT), for example of the type sold by Alfa Romeo under the trade name “Selespeed™”. In an AMT, a single clutch and associated gear pack couples with an output gear pack. When a gear change is required, the clutch disengages, the new gears synchronize and the clutch re-engages. A problem with AMTs is that, during gear changes, there is a significant torque interrupt as well as a rapid change in engine speed when the gear re-engages. To overcome these problems, previous approaches have been to speed up the synchronization process, which can damage the related components, or to control engine speed separately, which can give rise to additional control requirements.

Typically, hydraulic systems are used to actuate the displacement of shift rails and each hydraulic circuit is controlled by electrically actuated hydraulic spool valves.

### SUMMARY OF THE INVENTION

The invention is defined in the accompanying claims. Thus, there is provided a hydraulic circuit which enables both the pressure and the flow rate into and out of a gear selection actuator to be controlled.

### BRIEF DESCRIPTION OF THE DRAWINGS

The invention will now be described further, by way of example only, with reference to the accompanying drawings in which:

FIG. 1 is a schematic diagram of a known dual clutch transmission;

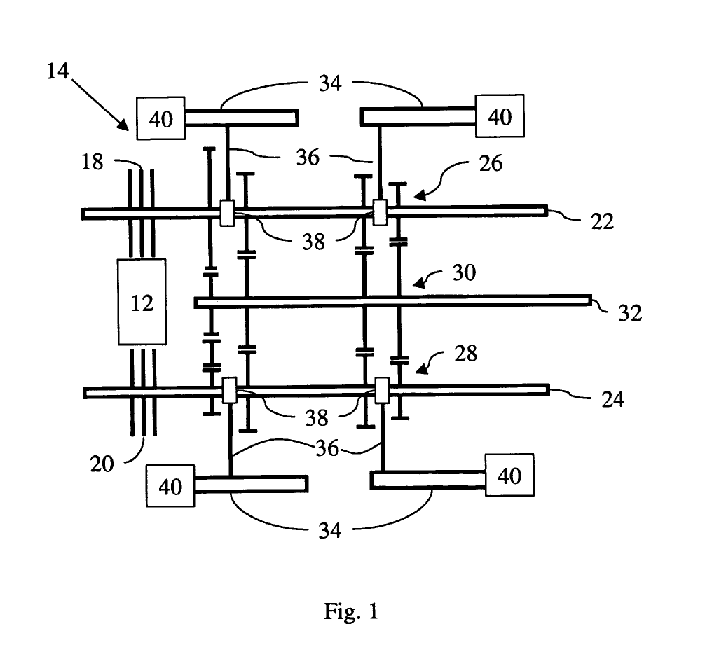

FIG. 2 shows a schematic diagram of a hydraulic control system for controlling movement of a gear in accordance with the invention;

FIG. 3 shows a more detailed schematic diagram of the hydraulic control system of FIG. 2;

FIGS. 4a and 4b show examples of displacement/time profiles for a gear; and

FIGS. 5a and 5b show examples of pressure and flow profiles with respect to time used to generate the example profiles shown in FIGS. 4a and 4b, respectively.

### DETAILED DESCRIPTION OF THE PREFERRED EMBODIMENT

A vehicle typically has a plurality of gears including reverse and typically at least four forward gears: first, second, third and fourth. In the embodiment to be described, an eight speed gear box will be described which provides gears as follows: reverse, 1, 2, 3, 4, 5, 6, 7.

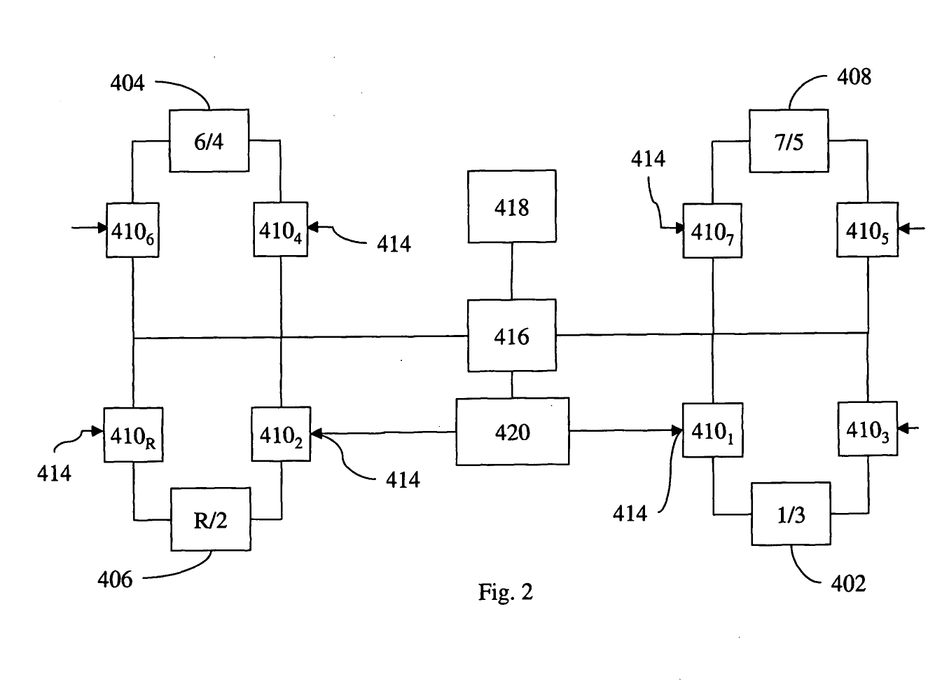

In the transmission system shown, different sets of gears are locked and unlocked to an output shaft to achieve the various gear ratios required. Locking and unlocking of the gears is performed by actuating a selector fork 36. To move the selector fork 36, hydraulic fluid is passed through conduits to actuate an actuator 40 and hence cause the selector fork 36 to move as required. Each selector fork 36 is controlled by a double acting actuator 40 (shown in more detail as actuators 402,404, 406,408 in FIG. 2) with pistons which are mechanically connected to the shift rails 34 within the transmission. The rails 34 support the gear selection forks 36 for the movement of splined selector rings 38 to lock and unlock the gears. The shift rails and actuators are arranged such that when the actuator pistons are energized in the neutral position, the actuator will be equidistant from both gears on the rail, with neither gear locked. The position of the selection forks is monitored via a linear displacement sensor, which forms the feedback loop to the control system.

FIG. 2 is a schematic diagram of circuitry according to the invention used to control movement of a shift rail. The embodiment shown in FIG. 2 has eight gears: reverse, first, second, third, fourth, fifth, sixth and seventh. These are provided in pairs. In the embodiment shown, the following gear pairs are provided: an actuator 402 for the first and third gear; an actuator 404 for the fourth and sixth; an actuator 406 for the reverse and second; and an actuator 408 for the fifth and seventh.

Each actuator has a pair of flow control valves 410 associated with it. In FIG. 2, numeral 410l indicates the flow control valve associated with the “into gear” side of the first gear, 4102 indicates the flow control valve associated with the “into gear” side of the second gear, and so on. These valves typically take the form of electrically actuated hydraulic spool valves. The pressure and flow of the hydraulic fluid entering and exiting the valves 410 controls the force and speed, respectively, with which the associated actuator is moved. The direction of movement of the actuator is dependant upon the controlled direction of fluid flow through the relevant pair of flow control valves 410.

The valves 410 are supplied with hydraulic fluid by a pressure control valve 416 and controlled by a flow control input 414. The pressure control valve 416 regulates the pressure of the hydraulic fluid supplied to the valves 410. The control input 414 of each flow control valve 410 controls the rate of flow of hydraulic fluid into the chamber of the actuator. The flow control valves 410 and pressure control valve 416 are themselves controlled by a control device 420 such as a microprocessor. (For simplicity, some of the flow control inputs 414 of the flow control valves 410 are shown un-connected to control device 420 although in practice they will be connected.) The control device 420 may also be used to control other features of the transmission or vehicle as a whole.

Gear change is controlled by the control device 420. The control device 420 may decide that a gear change is needed in response to a number of factors, e.g. engine speed (rpm), engine torque, terrain etc.

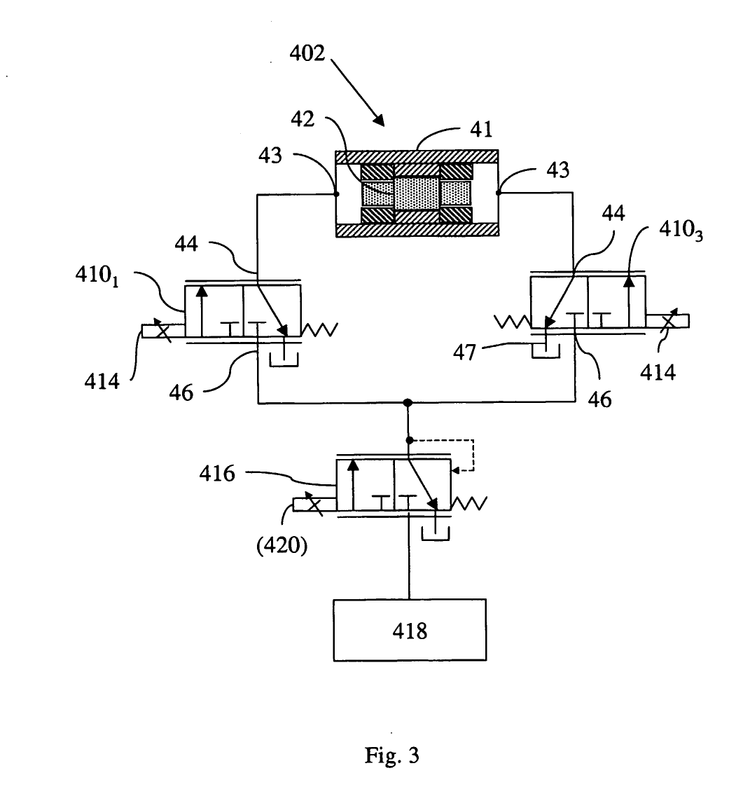

FIG. 3 shows the actuator arrangement in more detail. Only one actuator 402 is shown, however it will be appreciated that the other actuators 404,406, 408 are arranged in a similar manner. Each actuator comprises an actuator body 41 and an actuating member 42 in the form of a piston. The piston is connected to a shift rail 34. The actuators shown are double-acting actuators, i.e., they have openings 43 at opposite ends of the actuator body 41 for fluid to enter and exit the actuator body, one on the left and one on the right as shown in FIG. 3. To enable the gear actuating member 42 to be moved, a proportional 3-way/2 position flow control solenoid spool valve 410 is connected, via a control port 44, to each opening 43 of the actuator 402,404, 406,408. Each supply pressure port 46 of the flow control valves 410 is connected to the control port of a proportional 3-way/2 position pressure control solenoid spool valve 416. The supply pressure port of this valve 416 is connected to a hydraulic supply 418, consisting of a pump and an accumulator. The electrical control input 414 of each flow control valve 410 is connected to the microprocessor 420.

The proportional flow control valves 410 regulate the flow rate of the fluid from the control port 44 to the drain port 47 (when on the “drain” side of the actuator), or the pressure port 46 to the control port 44 (when on the “into gear” side of the actuator) in relation to the current applied to the solenoid of the valve 410. This affects the velocity and direction of movement of the actuating member 42. The fluid is typically oil, although other liquids or gases may be used.

The proportional pressure control valve 416 regulates the pressure of the fluid at its control port (and hence the pressure at the pressure port 46 of the flow control valves 410) in relation to the current applied to the solenoid of the pressure control valve 416. This affects the force applied to the actuating member 42.

To enable movement of the gear selector actuator, each of the valves 410,416 are operated in a suitable manner to achieve the desired velocity and force. This is achieved by use of the flow control valves 410 to determine the direction of movement of the actuator while the pressure control valve 416 regulates the supply pressure and hence the force generated by the actuator piston. The velocity of the actuator can be regulated by use of the flow control valve on the drain side of the actuator controlling the flow between its control and tank ports.

To enable swift selection (locking) of a synchronized gear in the transmission, the actuating member 42 (and hence the selection rail) is moved from the neutral position (i.e. both gears disengaged), towards the gear by placing the flow control valve 410 on the ‘into gear’ side of the actuator in a state where it commands maximum flow from its pressure to control ports, and the flow control valve 410 on the ‘drain’ side of the actuator in a state where it can regulate the flow out of the actuator by controlling flow between its control and tank ports.

To move a synchronizer clutch 38 of the first or second gear set (26,28 respectively) into engagement with a gear of the gear set, the appropriate actuator is actuated. This causes the associated shift rail 34 to move and hence the selection fork 36 and the associated synchronizer clutch 38 to be moved. Clearly, the synchronizer clutch 38 needs to move into the engaged position as quickly as possible but also as smoothly as possible. In a preferred embodiment, sequential gears are provided on different shift rails. This means that the transmission does not have to move directly from one gear on an input shaft to another gear on the same input shaft. This aids a smooth transition. The ideal gear shift is one that is smooth but fast. In each gear change, the teeth of the engaging gears and the synchronizer clutch 38 have to be brought into engagement in the smoothest possible manner. Clearly, since the gears are rotating at the time, this may be a delicate and precise operation.

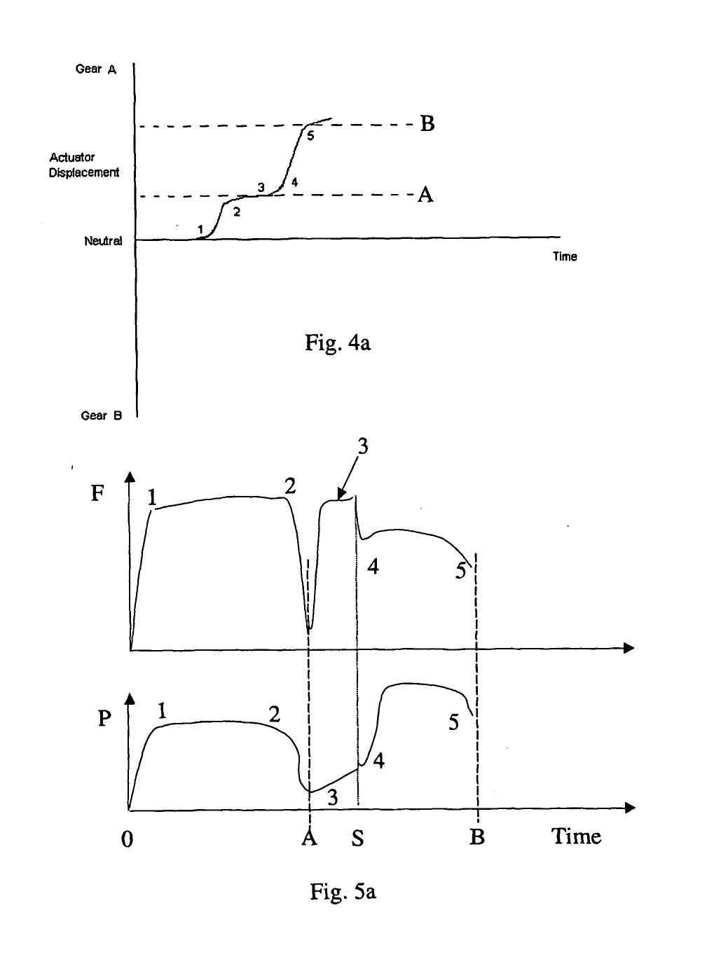

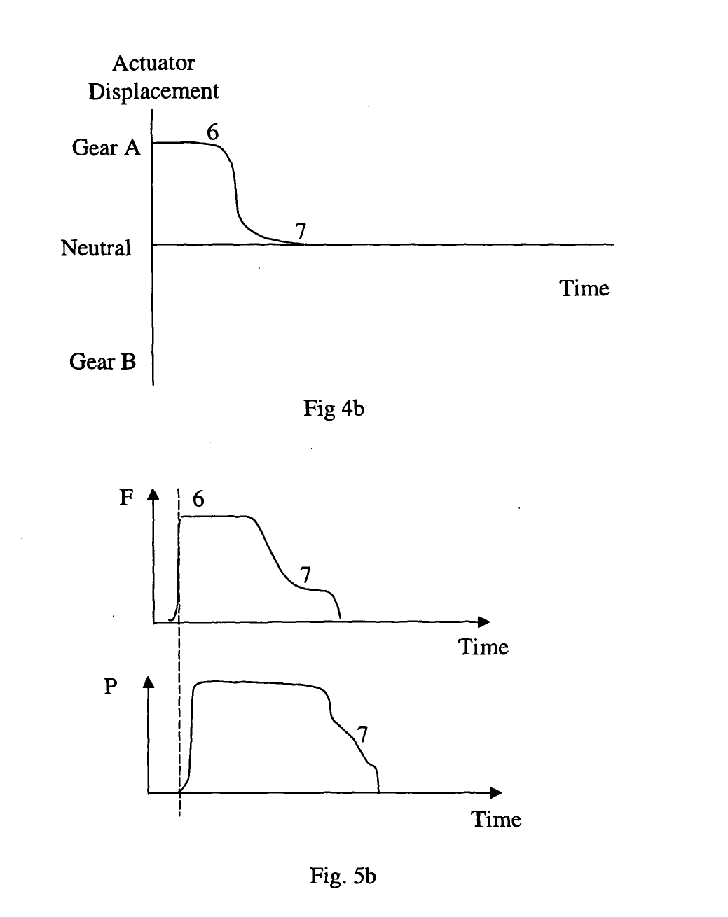

An example of the position profile of an actuator is shown in FIG. 4. FIG. 4a shows the position profile of a selector fork 36 when moving into engagement with gear A and FIG. 4b shows the position profile when moving out of engagement with gear A. FIG. 5 shows the corresponding pressure/flow profile for the gear. FIG. 5a shows a pressure/flow profile when moving into engagement with gear A and FIG. 5b shows the pressure/flow profile when moving out of engagement with gear A. The pressure characteristics are shown in the graph marked P and the flow demand characteristics are shown in the graph marked F. FIG. 5a shows an example of a pressure and flow profile with respect to time. Alternatively, the pressure and flow profile with respect to the position of the selector fork may be stored. A separate pressure and flow profile may be stored for each gear.

Considering FIGS. 4a and 5a, the pressure control valve 416 initially (1) is regulated to accelerate the actuator member 42, and therefore the selection rail 34, towards the gear to be selected according to the profile P. The ‘into gear’ flow control valve (410) is regulated to give maximum pressure to control port flow, as it is for the entire gear selection. The flow control valve on the ‘drain’ side of the actuator is regulated, also, to accelerate the actuator according to the profile F. As the actuator approaches a displacement (A) where the synchronizer clutch 38 for the gear will be engaged, the pressure is reduced (2) by the pressure control valve 416, and the flow control valve 410 on the ‘drain’ side of the actuator restricts the exhausting flow such that the actuator can be decelerated quickly. In this way, the effect of the operation of the synchronizer clutch on the output shaft torque of the transmission is minimized. As the synchronizer clutch 38 engages (3) with the gear, the actuator is prevented from further movement by the operation of a sychronizer clutch blocker. At this point, the pressure control valve 416 has a slowly rising pressure ramp applied (3) such that the synchronization takes place. During this time, the ‘drain’ side flow control valve 410 is regulated to allow maximum control-to-tank-port flow (3). Upon synchronization (S), the synchronizer blocker is released and the actuator is again free to move. The actuator is accelerated by an increasing pressure command (4) from the pressure control valve 416, and regulated on the ‘drain’ side of the actuator by the flow control valve 410. As the actuator approaches a position (B) where the gear is fully engaged (5), the actuator is decelerated by a reduction (5) in the regulated pressure of the pressure control valve 416, and the restriction (5) of the exhausting flow on the ‘drain’ side of the actuator by the flow control valve 410.

When the control device 420 decides that a gear change is required and which gear is to be engaged, the control device 420 retrieves the flow/pressure profile for the gear being brought into engagement. The control device sends a signal to the appropriate pressure control valve 416. This, in turn, supplies a controlled pressure supply to the appropriate flow control valve 410 and hence the pressure of the fluid applied to the associated actuator. A control signal is also sent from the control device 420 to the control input 414 of the flow control device 410 to control the flow rate of the hydraulic fluid through the valve 410 and hence into, or out of, the associated actuator.

This may be illustrated by considering the example of changing the gear from second to fourth. In second gear, the gear of the second gear set 28 is engaged with a gear of the output gear set 30. When the control device 420 decides that a gear change from second to fourth is required, the control device 420 accesses the gear profile for the fourth gear and, in response to data read from the profile, sends a control signal to the pressure control valve 416 and the control input 414 of the actuator 404 for the fourth gear. In response, the pressure control valve 416 sets the pressure of the hydraulic fluid applied to the flow control valve 4104 for the fourth gear as set in the fourth gear profile and the control device 414 sets the flow of the hydraulic fluid of the actuator 4104 of the fourth gear. The control signals to the control devices 416 and 414 alter in line with the profile as the position of the gear for the fourth gear alters.

FIGS. 4b and 5b show examples of actuator displacement and pressure/flow profiles respectively for disengagement of a gear. In the case of disengagement, a command is sent to the pressure control valve 416 according to profile P and a command is sent to both flow control valves associated with an actuator (e.g. flow valves 410, and 4103 associated with actuator 402) to allow flow from the pressure port to the control port according to profile F, such that the actuator accelerates towards neutral.

As the actuating member nears the neutral position, the actuator is then slowed (7) by reducing the regulated pressure of the pressure control valve 416 and reducing the flow to both flow control valves 410. In this way, the severity of mechanical noise caused by the actuator pistons stopping suddenly in the neutral position is reduced.

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than a restrictive sense.

For instance, the invention may be applied to gearbox technologies other than that described with reference to the drawings (e.g. AMTs).

1. An actuator for actuating a gear shift mechanism in a vehicular transmission system, the actuator comprising: an actuator body having an opening for the transport of fluid into and out of the actuator body; an actuating member within the actuator body, moveable by the fluid; and a control device operable to control independently the pressure of the fluid and the flow of the fluid.

2. An actuator according to claim 1, wherein the control device comprises a proportional flow control valve to regulate the flow of fluid into and out of the actuator body.

3. An actuator according to claim 1, wherein the control device comprises a proportional pressure control valve to regulate the pressure of the fluid into and out of the actuator body.

4. An actuator according to claim 1, wherein the control device is operable to control the pressure of the fluid in dependence on a pre-defined profile of pressure with respect to a position of the actuating member.

5. An actuator according to claim 1, wherein the control device is operable to control the flow of the fluid in dependence on a pre-defined profile of flow with respect to a position of the actuating member.

6. An actuator according to claim 1, wherein the control device is operable to control at least one of the pressure and flow by a current signal.

7. An actuator according to claim 1, wherein the actuator is a hydraulically operated actuator.

8. A method of controlling an actuator for actuating a gear shift mechanism in a vehicular transmission system, the actuator comprising an actuator body having an opening for the transport of fluid into and out of the actuator body and an actuating member within the actuator body, moveable by the fluid; the method comprising: independently controlling the pressure of the fluid and the flow of the fluid.

9. A method according to claim 8 further comprising controlling the pressure of the fluid in dependence on a pre-defined profile of pressure with respect to a position of the actuating member.

10. A method according to claim 8, further comprising controlling the flow of the fluid in dependence on a pre-defined profile of flow with respect to a position of the actuating member.

11. A method according to claim 8, further comprising controlling at least one of the pressure and flow by a current signal.

12. A method according to claim 8, wherein the fluid is a liquid.
